(19) United States
(12) Patent Application Publication
(10) Pub. No.: US 2015/0295469 A1
(43) Pub. Date: Oct. 15, 2015

(54) MAGNETIC GADOLINIUM PROPULSION GENERATOR

(71) Applicant: Meir ALFASI, Miramar, FL (US)

(72) Inventor: Meir ALFASI, Miramar, FL (US)

(21) Appl. No.: 14/449,947

(22) Filed: Aug. 1, 2014

Related U.S. Application Data
(60) Provisional application No. 61/979,565, filed on Apr. 15, 2014.

(51) Int. Cl. H02K 7/18

(52) U.S. Cl. CPC H02K 7/1807

(57) ABSTRACT

An electrical generator is provided. The electrical generator may include a shaft and a rotor. The rotor may be connected to the shaft and may rotate about the axis of the shaft. The present invention may further include a plurality of magnetic blocks and a plurality of attractant blocks. The plurality of attractant blocks may include a first set and a second set in an alternating arrangement. The attractant blocks may include gadolinium. Therefore, a temperature regulator may heat and cool the attractant blocks in order to rotate the rotor and produce energy.

### CROSS-REFERENCE TO RELATED APPLICATION

This application claims the benefit of priority of U.S. provisional application No. 61/979,565, filed Apr. 15, 2014, the contents of which are herein incorporated by reference.

### BACKGROUND OF THE INVENTION

The present invention relates to electrical generators and, more particularly, to a magnetic gadolinium propulsion generator.

In electricity generation, an electric generator is a device that converts mechanical energy to electrical energy. A generator forces electric current to flow through an external circuit. The source of mechanical energy may be a reciprocating or turbine steam engine, water falling through a turbine or waterwheel, an internal combustion engine, a wind turbine, a hand crank compressed air, or any source of mechanical energy. Generators provide nearly all of the power for electric power grids. Efficient, inexpensive, and clean electric generators are highly desirable.

As can be seen, there is a need for a clean, inexpensive, and efficient electric generator.

### SUMMARY OF THE INVENTION

In one aspect of the present invention, a generator comprises: a shaft; a rotor rotatable about the axis of the shaft; a plurality of magnetic blocks; a plurality of attractant blocks comprising a first set and a second set in an alternating arrangement, wherein each of the attractant blocks comprise gadolinium; and a temperature regulator configured to activate and deactivate the magnetism of the plurality of attractant blocks, alternating between the first set and the second set; wherein one of the plurality of magnetic blocks and the plurality of attractant blocks is circumferentially attached to the rotor, and one of the plurality of magnetic blocks and the plurality of attractant blocks are in a fixed position encircling the rotor.

These and other features, aspects and advantages of the present invention will become better understood with reference to the following drawings, description and claims.

### BRIEF DESCRIPTION OF THE DRAWINGS

FIG. 1 is a perspective view of the present invention in a neutral position;

FIG. 2 is a perspective view of the invention of the neodymium magnetic blocks attracted to the second set of gadolinium metal and detracted from the first set of gadolinium metal;

FIG. 3 is a perspective view of the present invention of the magnetic blocks attracted to the first set gadolinium metal and detracted from the second set of gadolinium metal; and

FIG. 4 is a flowchart illustrating the operation of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a magnetic gadolinium propulsion generator that generates mechanical and in turn electrical energy. The present invention utilizes magnets and gadolinium metal. The present invention may further include a fluid such as water, refrigerant or gas at different temperatures to create mechanical energy and electricity by using Gadolinium Gd 64 metal or Gadolinium alloy characteristics. The present invention facilitates an inexpensive method of generating electricity.

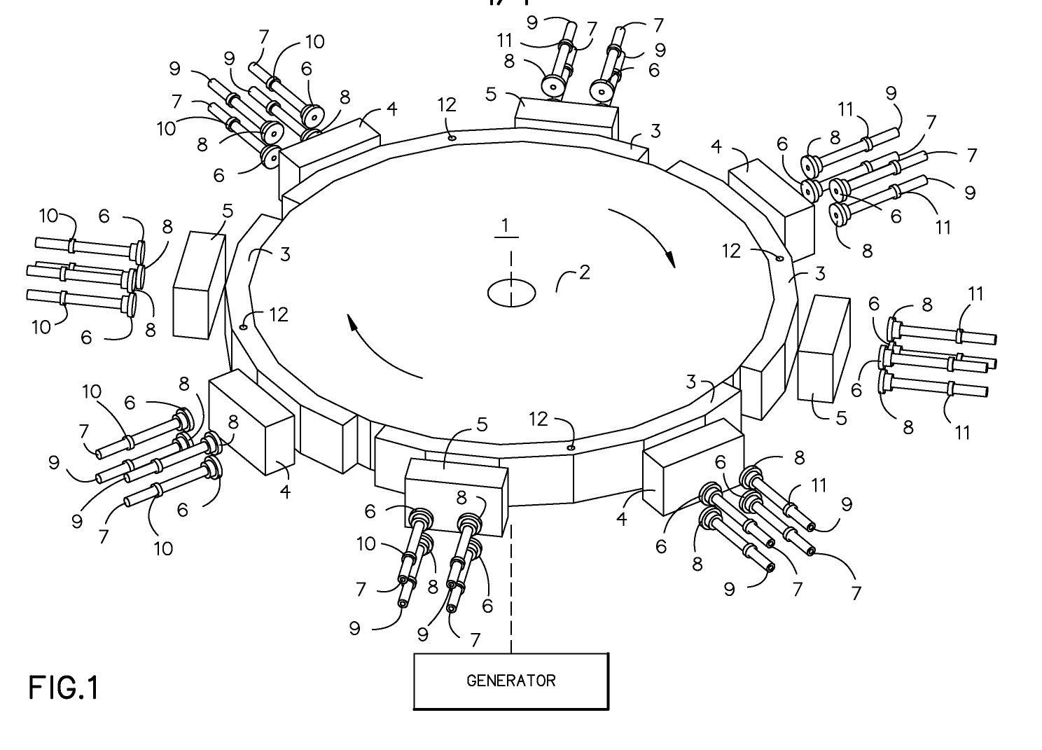

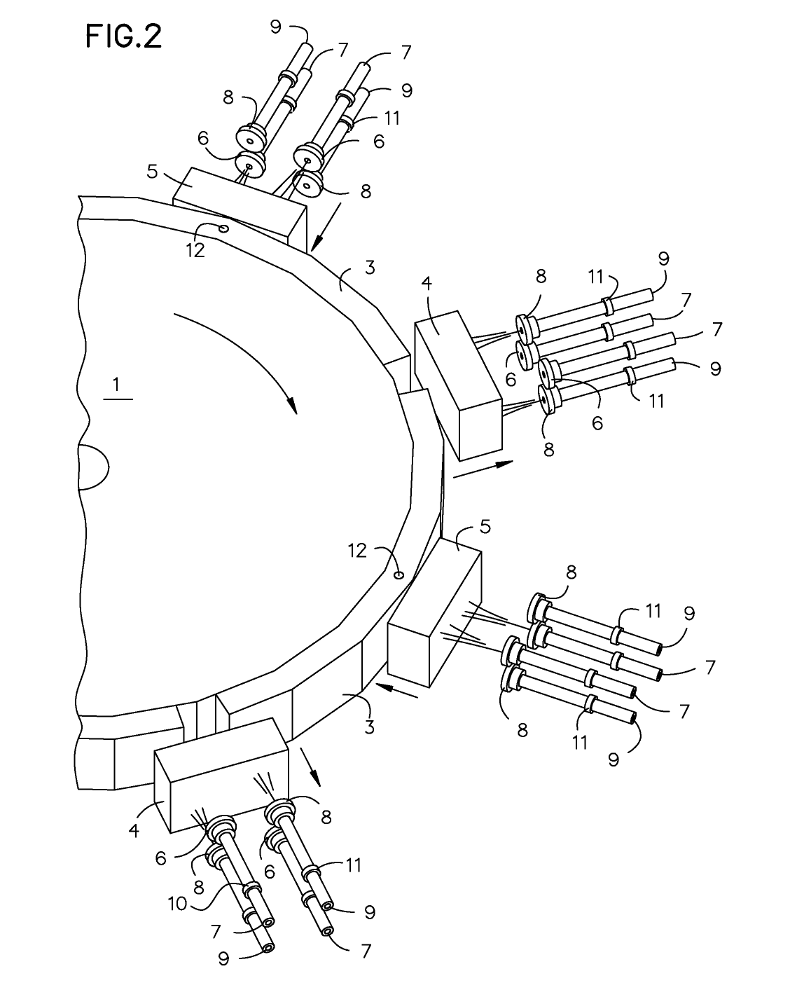

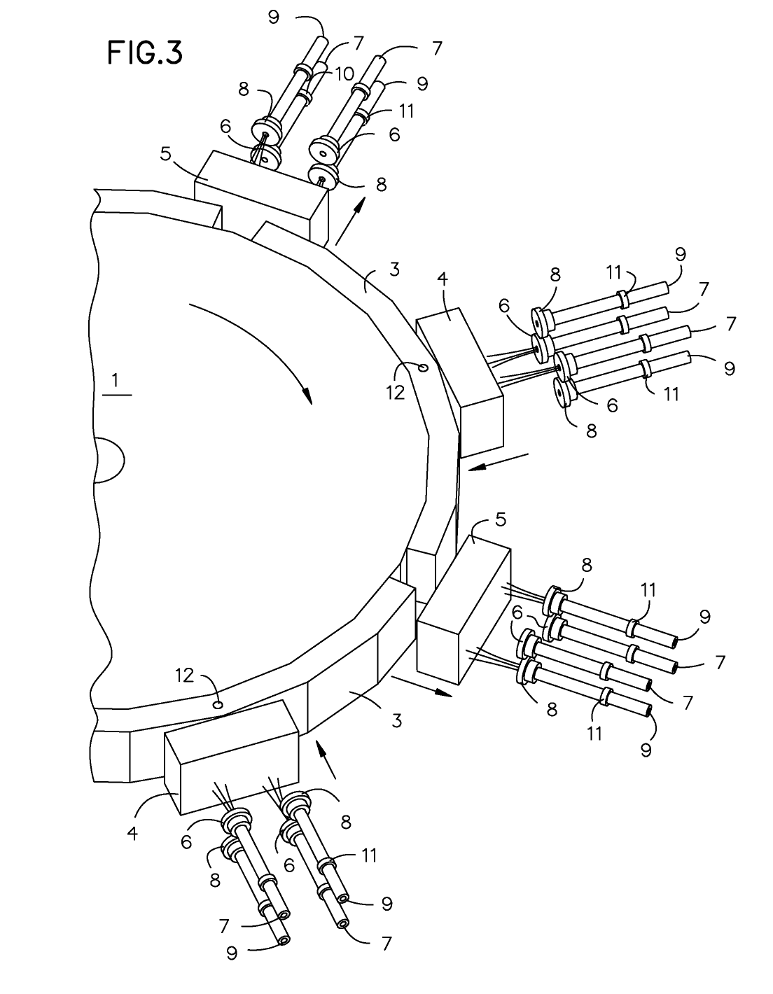

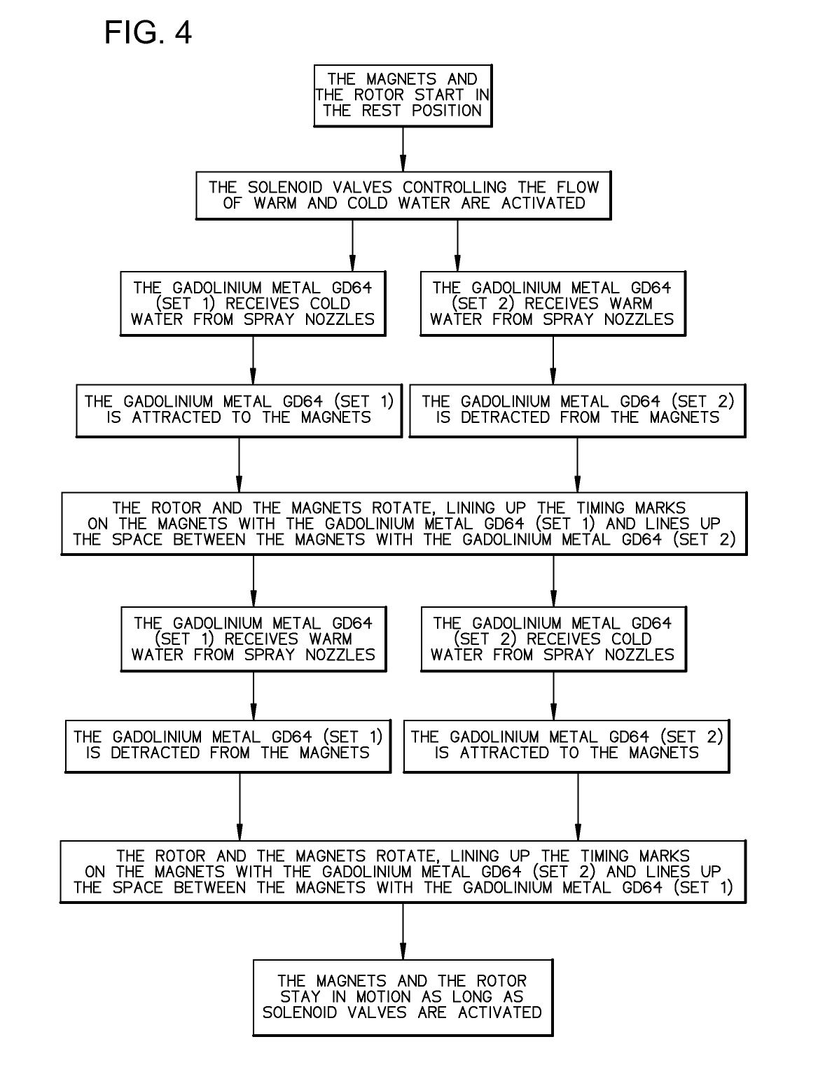

Referring now to FIGS. 1 through 4, the present invention includes an electrical generator. The electrical generator may include a shaft 1 and a rotor 2. The rotor 2 may be connected to the shaft 1 and may rotate about the axis of the shaft 1. The present invention may further include a plurality of magnetic blocks 3 and a plurality of attractant blocks 4, 5. The plurality of attractant blocks 4, 5 may include a first set 4 and a second set 5 in an alternating arrangement. The attractant blocks 4, 5 may include gadolinium. Therefore, a temperature regulator may heat and cool the attractant blocks 4, 5 in order to rotate the rotor 2 and produce energy.

Either the plurality of attractant blocks 4, 5 is attached to the rotor 2 and rotates, or the plurality of magnetic blocks 3 is attached to the rotor 2 and rotates. Likewise, either the plurality of attractant blocks 4, 5 is in a fixed position around the rotor 2 or the plurality of magnetic blocks 3 is in a fixed position around the rotor 2. As illustrated in the Figures, the plurality of magnetic blocks 3 is four magnetic blocks 3 attached circumferentially to the rotor's edge and equally spaced apart. Further, the plurality of attractant blocks 4, 5 is in a fixed position with eight attractant blocks 4, 5 equally spaced apart around the magnetic blocks 3, with the first set 4 and the second 5 alternating. The first set 4 and the second set 5 may be oriented close to the magnetic blocks 3 without touching the magnetic blocks 3.

As mentioned above, the attractant blocks 4, 5 may include gadolinium. However, the attractant blocks 4, 5 may include other metals that are mixed with gadolinium that may or may not enhance the effects. Further, the attractant blocks 4, 5 may include gadolinium alloys. The magnetic blocks 3 may be any magnetic material. For example, the magnetic block 3 may be a neodymium magnet, or an electromagnet.

The temperature regulators are configured to activate and deactivate the magnetism of the plurality of attractant blocks 4, 5, alternating between the first set 4 and the second set 5. The temperature regulators may be heat exchangers, delivery devices, or the like. In certain embodiments, the temperature regulators include a plurality of cold spray nozzles 6 and a plurality of warm spray nozzles 8. In certain embodiments, two cold spray nozzles 6 and two warm spray nozzles 8 may be directed at each of the attractant blocks 4, 5. The cold spray nozzles 6 may deliver a cold substance to the attractant blocks 4, 5, thereby activating the magnetism, and the warm spray nozzles 8 may deliver a warm substance to the attractant blocks 4,5, therefore deactivating the magnetism.

In certain embodiments, the cold and warm substance may be a gas, such as air, electricity, or a liquid, such as water. The cold and warm substance may be in a closed loop, and therefore reused. As illustrated in the Figures, the plurality of cold spray nozzles 6 may be connected with a cold substance supply 7, and the plurality of warm spray nozzles 9 may be connected with a warm substance supply 9.

Gadolinium metal becomes ferromagnetic at temperatures of 68° F. and below, and paramagnetic at temperatures above 68° F. Therefore, the cold substance may be at a temperature to change the plurality of attractant blocks 4, 5 to about 68° F. and below at a relatively fast pace. Likewise, the warm substance may be at a temperature to change the plurality of attractant blocks 4, 5 to above 68° F. at a relatively fast pace. Alternating the delivery of the hot and cold substance between the first set 4 and the second set 5 will alternate the magnetic attraction of the attractant blocks 4, 5 and thereby spin the rotor 2.

In certain embodiments, the cold spray nozzles 6 includes a cold nozzle solenoid valve 10, and the warm spray nozzles 8 includes a warm nozzle solenoid valve 11. The present invention may further include at least one timing mark 12. As illustrated in the Figures, the at least one timing mark 12 may be four timing marks at each quadrant of the rotor. A computer may gauge the distance the rotor traveled by using the timing marks 12. The distance traveled may indicate when a cold spray nozzle 6 is activated and a warm spray nozzle 8 is deactivated as well as when a cold spray nozzle 6 is deactivated and a warm spray nozzle 8 is activated. The computer controls the delivery of the cold substance and the warm substance via the solenoid valves 10, 11.

A method of generating electricity using the generator described above may include the following. The first set 4 of attractant blocks 4, 5 may be aligned at a space in between the magnetic blocks 3 or alternatively, the rotor 2 may be spun. The cold substance may be sprayed onto the first set 4, thereby magnetizing the first set 4. The warm substance may be sprayed onto the second set 5, thereby demagnetizing the second set 5. The rotor 2 may rotate due to the magnetic force of the magnet 3 attracting to the magnetized first set 4. After the rotor 2 has traveled a quadrant, the first set 4 may be sprayed with the warm substance and the second set 5 may be sprayed with the cool substance. Therefore, the first set 4 is now demagnetized, while the second set 5 is magnetized. The rotor 1 may continue to rotate towards the second set 5. The first set 4 and the second set 5 may periodically change temperatures from above and below 68° F., and therefore the rotor may continue to spin and generate energy.

By using different temperatures to change the gadolinium affect on a magnet one can create mechanical energy that can produce electricity just by having a cold and warm source of fluid like water or gas. One can use the present invention to drive most things that need mechanical or electrical energy. The present invention can be use in a large scale such as a power plant and can be used in a small scale such as a house or a building complex.

It should be understood, of course, that the foregoing relates to exemplary embodiments of the invention and that modifications may be made without departing from the spirit and scope of the invention as set forth in the following claims.

What is claimed is:

1. A generator comprising:
a rotatable rotor;
a plurality of magnetic blocks;
a plurality of attractant blocks comprising a first set and a second set in an alternating arrangement, wherein each of the attractant blocks comprise gadolinium; and
a temperature regulator configured to activate and deactivate the magnetism of the plurality of attractant blocks, alternating between the first set and the second set;
wherein one of the plurality of magnetic blocks and the plurality of attractant blocks is circumferentially attached to the rotor, and one of the plurality of magnetic blocks and the plurality of attractant blocks are in a fixed position encircling the rotor.

2. The generator of claim 1, further comprising a shaft, wherein the rotor is attached to the shaft and rotates about the axis of the shaft.

3. The generator of claim 1, wherein the plurality of magnetic blocks comprise neodymium.

4. The generator of claim 1, wherein the plurality of magnetic blocks is circumferentially attached to an outside edge of the rotor, and the plurality of attractant blocks is in a fixed position encircling the rotor.

5. The generator of claim 4, wherein the plurality of magnetic blocks comprises four magnetic blocks equally spaced apart around the rotor and the plurality of attractant blocks comprises eight attractant blocks equally spaced apart around the magnetic blocks, wherein four of the attractant blocks are part of the first set, and four of the attractant blocks are part of the second set.

6. The generator of claim 4, wherein the temperature regulator comprises a plurality of cold spray nozzles operable to deliver a cold substance, and a plurality of warm spray nozzles operable to deliver a warm substance, wherein a cold spray nozzle and a warm spray nozzle are directed at each of the attractant blocks, wherein the cold spray nozzle is activated to activate the magnetism and the warm spray nozzle is activated to deactivate the magnetism.

7. The generator of claim 6, wherein the cold substance and the warm substance is at least one of a gas and a liquid.

8. The generator of claim 6, wherein the cold substance is operable to change the temperature of the plurality of attractant blocks to about 68° F. and below and the warm substance is operable to change the temperature of the plurality of attractant blocks to above about 68° F.

9. The generator of claim 6, wherein the cold spray nozzles and the warm spray nozzles each comprise a solenoid valve, wherein a computer controls the delivery of the cold substance and the warm substance via the solenoid valves.

10. The generator of claim 9, further comprising at least one timing mark, wherein a distance traveled by the at least one timing mark indicates when a cold spray nozzle is activated and a warm spray nozzle is deactivated as well as when a cold spray nozzle is deactivated and a warm spray nozzle is activated.

11. The generator of claim 10, wherein the at least one timing mark is four timing marks at each quadrant of the rotor.

12. The generator of claim 11, wherein when the rotor travels a quadrant, the activation of the cold spray nozzles and the warm spray nozzle are switched.
